(19) United States
(12) Patent Application Publication
(10) Pub. No.: US 2025/0384668 A1
(43) Pub. Date: Dec. 18, 2025

(54) COMPUTER SYSTEM, METHOD, AND DEVICE FOR ACTIVE LEARNING

(71) Applicant: Musashi AI North America Inc., Waterloo (CA)

(72) Inventors: Martin Bufi, Waterloo (CA); Saeed Mahdizadeh Bakhshmand, Waterloo (CA); Rostyslav-Mykola Tsenov, Waterloo (CA); Mahesh Sudhakar, Waterloo (CA); Jasmeen Kaur, Kitchener (CA)

(21) Appl. No.: 18/879,410

(22) PCT Filed: Jun. 30, 2023
(86) PCT No.: PCT/CA2023/050904

§ 371 Date: Dec. 27, 2024

Related U.S. Application Data
(60) Provisional application No. 63/357,242, filed on Jun. 30, 2022.

(51) Int. Cl. G06V 10/774; G06F 11/30; G06F 11/34; G06F 16/53; G06F 16/55

(52) U.S. Cl. CPC G06V 10/774; G06F 11/302; G06F 11/3409; G06F 16/53; G06F 16/55

(57) ABSTRACT

Systems, and methods, and devices for active learning are provided. The system includes a data storage device, dataset analysis tool, synthetic data generation module, anomaly module, image search engine module, explainable AI module, automated training platform, and optionally, a federated learning module. The system may be configured to operate on a general purpose or purpose-built computer, and may further include a processor, memory, and network interface. The system, through interaction of its constituent components, analyzes a provided dataset and generates synthetic data to augment data within the provided dataset. This provided data and generated data is used to train a machine learning model. The system may be operated iteratively to continuously improve the machine learning model trained by the system by applying explainable artificial intelligence techniques with little to no human intervention.

### TECHNICAL FIELD

The following relates generally to machine learning and artificial intelligence, and more particularly to systems and methods for active learning.

### INTRODUCTION

Current active learning systems and methods are limited in functionality and may provide for relatively poor or unreliable performance. Such limitations may be exacerbated by inherent limitations in sample and training datasets.

Accordingly, there is a need for an improved system, method, and device for active learning that overcomes at least some of the disadvantages of existing systems and methods.

### SUMMARY

Systems, methods, and devices implementing an active learning platform for training and deploying machine learning based models are provided.

The platform is provided with an initial training dataset for training a machine learning model. A processor of the system is configured to execute a dataset analysis tool to perform a pre-analysis on the dataset. The dataset analysis may be on a class-by-class basis. This analysis may include data sample size and sparsity calculations.

If the dataset analysis tool determines that the dataset is insufficient, the dataset analysis tool is configured to identify areas of insufficiency in the dataset. The areas of insufficiency in the dataset may be described to a synthetic data generation component by the dataset analysis tool. The synthetic data generation component generates appropriate synthetic data to augment the dataset based on the information provided by the dataset analysis tool. The dataset analysis tool may be re-executed to re-assess the sufficiency of the augmented dataset.

If the augmented dataset is deemed to be sufficient, the processor applies the augmented dataset to train a machine learning model to generate a trained machine learning model.

The processor is configured to assess performance of the trained machine learning model by providing a verification dataset to the model. If certain samples of the verification dataset result in poor performance or an incorrect output when provided to the trained machine learning model, these certain samples, or portions of these certain samples, may be provided to a search engine module. The search engine module may be an image search engine. The search engine module scans a database to locate data (e.g. images) similar to these certain samples. If such data is not available in the database, the system may call a synthetic data generation module to generate synthetic data similar to these certain samples. The model is then retrained using the generated synthetic data.

This system may repeat this process until acceptable model performance is achieved. In some cases, acceptable model performance may be determined by a user by, for example, evaluating performance metrics rendered in a graphical user interface by the system. In some cases, acceptable model performance may be determined automatically by the system by referencing one or more performance metric threshold metrics. Once acceptable model performance is achieved, the model may be deployed, or provided for further federated training, then deployed.

A computer-implemented method of performing active learning for training and deploying a machine learning model is provided. The method comprises: storing, in a data storage device, an image database comprising a first training dataset of training samples; determining, using a dataset analysis tool executed by at least one processor in communication with the data storage device, a clustering or distribution of the first training dataset; in response to the clustering or distribution determination, generating by a synthetic image generation module executed by the at least one processor a first set of one or more synthetic images using a subset of the training samples from the first training dataset as input and generating a second training dataset including the first set of one or more synthetic images; training the machine learning model with the second training dataset to obtain the trained machine learning model; assessing, using a model performance assessment tool executed by the at least one processor, a performance of the trained machine learning model, the assessing including identifying one or more images in the second training dataset negatively affecting model performance; sending a request for one or more training samples to an image search engine executed by the at least one processor, wherein the requested training samples are defined using image data from the identified one or more images negatively affecting model performance; running the image search engine to search the image database for the requested one or more training samples; where the image search engine returns the requested one or more training samples: generating a third training dataset including the requested one or more training samples; training the machine learning model with the third training dataset to obtain the trained machine learning model; where the image search engine does not return the requested one or more training samples: generating, by the synthetic image generation module, a second set of one or more synthetic images using image data from the one or more images in the first training dataset that have contributed to unacceptable model performance as input and generating a fourth training dataset including the second set of one or more synthetic images; and training the machine learning model with the fourth training dataset to obtain the trained machine learning model.

Determining the clustering or distribution of the first training dataset may include calculating sample size and sparsity of datapoints within the first training dataset.

Determining the clustering or distribution of the first training dataset may include performing an analysis operation to place the training samples into clusters, wherein the training samples within each cluster include similarities, and quantifying variation of the training samples within each cluster.

Determining the clustering or distribution of the first training dataset may include the dataset analysis tool determining an ability to generalize over the training samples is insufficient.

The synthetic image generation module may include a neural network and be configured to receive one or more training samples of a certain image class and generate and output one or more synthetic images of the same image class.

Assessing the performance of the trained machine learning model may include determining that an accuracy of classification of the trained machine learning model does not meet a predetermined accuracy threshold.

The image database may include a plurality of indexed images and the image search engine may be configured to analyze an input image and the plurality of indexed images and return references to images in the plurality of indexed images which are similar to the input image.

The image search engine may be configured to generate a feature embedded vector corresponding to the input image and search the plurality of indexed images using the feature embedded vector.

The model performance assessment tool may be configured to detect a region or regions in the one or more images in the second training dataset negatively affecting model performance, and the input image to the image search engine may be a cropped image containing the detected region or regions.

The machine learning model may be configured to perform at least one computer vision task including any one or more of object detection, object tracking, image classification, semantic segmentation, and instance segmentation.

Assessing the performance of the trained machine learning model may include generating, by the model performance assessment tool, an output including any one or more of predictions, confidence levels, heat maps, and other information that describes how inputs affect internal layers and activation information of layers of the trained machine learning model.

Assessing the performance of the trained machine learning model may include measuring, by the model performance assessment tool, model output accuracy of the trained machine learning model versus a known sample set, the measuring including measuring performance of the trained machine learning model versus known samples and comparing performance to a predetermined threshold of any one or more of precision, recall, and intersection over union.

The method may further include performing, using at least one federated learning module executed by the at least one processor, a federated learning process using the trained model and additional training data to further train the trained machine learning model to obtain a federated-trained machine learning model, and the method may further include assessing performance of the federated-trained machine learning model using the model performance assessment tool.

The additional training data may be from at least two physical sites implementing computer vision-based visual inspection.

A computer system for performing active learning for training and deploying a machine learning model is also provided. The system includes: a data storage device for storing an image database comprising a first training dataset of training samples; at least one processor in communication with the data storage device, the at least one processor configured to: determine, using a dataset analysis tool, a clustering or distribution of the first training dataset; in response to the clustering or distribution determination, generate by a synthetic image generation module a first set of one or more synthetic images using a subset of the training samples from the first training dataset as input and generate a second training dataset including the first set of one or more synthetic images; train, using an automated training module, the machine learning model with the second training dataset to obtain the trained machine learning model; assess, using a model performance assessment tool, a performance of the trained machine learning model, the assessing including identifying one or more images in the second training dataset negatively affecting model performance; send a request for one or more training samples to an image search engine, wherein the requested training samples are defined using image data from the identified one or more images negatively affecting model performance; run the image search engine to search the image database for the requested one or more training samples; where the image search engine returns the requested one or more training samples: generate a third training dataset including the requested one or more training samples; train the machine learning model with the third training dataset to obtain the trained machine learning model; where the image search engine does not return the requested one or more training samples: generate, by the synthetic image generation module, a second set of one or more synthetic images using image data from the one or more images in the first training dataset that have contributed to unacceptable model performance as input and generate a fourth training dataset including the second set of one or more synthetic images; and train the machine learning model with the fourth training dataset to obtain the trained machine learning model.

Determining the clustering or distribution of the first training dataset may include performing an analysis operation to place the training samples into clusters, wherein the training samples within each cluster include similarities, and quantifying variation of the training samples within each cluster.

The synthetic image generation module may include a neural network and may be configured to receive one or more training samples of a certain image class and generate and output one or more synthetic images of the same image class.

Assessing the performance of the trained machine learning model may include determining that an accuracy of classification of the trained machine learning model does not meet a predetermined accuracy threshold.

The image database may include a plurality of indexed images and the image search engine may be configured to analyze an input image and the plurality of indexed images and return references to images in the plurality of indexed images which are similar to the input image.

A non-transitory computer-readable medium is provided storing computer-executable instructions which, when executed by at least one processor, cause the at least one processor to execute a method comprising: storing, in a data storage device, an image database comprising a first training dataset of training samples; determining, using a dataset analysis tool executed by at least one processor in communication with the data storage device, a clustering or distribution of the first training dataset; in response to the clustering or distribution determination, generating by a synthetic image generation module executed by the at least one processor, a first set of one or more synthetic images using a subset of the training samples from the first training dataset as input and generating a second training dataset including the first set of one or more synthetic images; training the machine learning model with the second training dataset to obtain the trained machine learning model; assessing, using a model performance assessment tool executed by the at least one processor, a performance of the trained machine learning model, the assessing including identifying one or more images in the second training dataset negatively affecting model performance; sending a request for one or more training samples to an image search engine executed by the at least one processor, wherein the requested training samples are defined using image data from the identified one or more images negatively affecting model performance; running the image search engine to search the image database for the requested one or more training samples; where the image search engine returns the requested one or more training samples: generating a third training dataset including the requested one or more training samples; training the machine learning model with the third training dataset to obtain the trained machine learning model; where the image search engine does not return the requested one or more training samples: generating, by the synthetic image generation module, a second set of one or more synthetic images using image data from the one or more images in the first training dataset that have contributed to unacceptable model performance as input and generating a fourth training dataset including the second set of one or more synthetic images; and training the machine learning model with the fourth training dataset to obtain the trained machine learning model.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a schematic diagram of a system for active learning, according to an embodiment;

FIG. 2 is a block diagram of a computing device of the present disclosure, according to an embodiment;

FIG. 3 is a block diagram of a computer system for active learning, according to an embodiment;

FIG. 4 is a flow diagram of a method of active learning using the system/platform of FIG. 3, according to an embodiment; and

FIG. 5 is a flow diagram of a method of active learning using the system/platform of FIG. 3, according to another embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to an active learning platform for training and deploying machine learning based models.

Machine learning models may be deployed for use in a variety of tasks. For example, machine learning models may be applied to speech recognition, text translation, image classification, object inspection, and other tasks.

In general, such machine learning models may be generated by training an untrained machine learning model with a training dataset. In some use cases, the training dataset may be limited or insufficient in some manner, such as by having a limited number of training samples, resulting in a trained model with poor performance. It may be difficult to detect before deployment whether a model training dataset is such that the model may be trained and provide for high performance.

Additionally, in examples wherein the training dataset is insufficient, it may be difficult to determine why a training dataset is insufficient or how to improve a training dataset, such that the training dataset is sufficient. Finally, if it is known how and why a dataset is insufficient, it may be difficult to easily and efficiently augment that dataset, to correct its shortcomings.

Described herein are systems and associated methods for an active learning platform. The platform may be provided with an initial training dataset for training a machine learning model. The platform may first perform a pre-analysis on the dataset, on a class-by-class basis. This analysis may include data sample size and sparsity calculations.

If such a dataset analysis determines that the dataset is insufficient, areas of insufficiency may be identified, and described to a synthetic data generation component, such that appropriate synthetic data may be generated to augment the dataset. The dataset analysis tool may be re-executed to re-assess the sufficiency of the augmented dataset.

If the augmented dataset is deemed to be sufficient, the augmented dataset may then be applied to train a machine learning model, producing a trained machine learning model.

The trained machine learning model may be assessed for performance by providing a verification dataset to the model. If certain samples of the verification dataset result in poor performance or an incorrect output when provided to the trained machine learning model, these certain samples, or portions of these certain samples, may be provided to a search engine module. The search engine module may scan a database to locate data similar to these certain samples. If such data is not available, the system may call a synthetic data generation module to generate synthetic data similar to these certain samples and retrain the model using the generated synthetic data.

This process may repeat until acceptable model performance is achieved. Acceptable model performance may be determined by a user by, for example, evaluating performance metrics rendered in a graphical user interface by the system, or may be determined automatically by the system by referencing one or more performance metric threshold metrics. Once acceptable model performance is achieved, the model may be deployed, or provided for further federated training, then deployed.

Such a system and associated method may improve the performance of machine learning models, especially in examples wherein the training dataset is inherently limited or difficult to acquire. The system allows for re-training, visibility, and automation of the entire artificial intelligence pipeline.

While much of the present disclosure is provided in the context of defect detection and visual inspection of objects (including manufacturing quality control and visual inspection), the systems, methods, and devices provided herein may have further applications and different uses beyond those described herein, whether in the context of defect detection and visual inspection of objects or otherwise (e.g. other computer vision applications, such as self-driving vehicles, medical image analysis, robotics using manipulation, etc.). Machine-learning models described herein, whether called models or object detection models, may in other embodiments be other forms of machine learning models configured to perform machine learning or computer vision tasks other than object detection. For example, the multi-model architecture described herein may include a plurality of neural networks configured to perform object detection or other image processing or computer vision tasks. Input data may vary in those cases, as may output data, but elements of the present disclosure, such as multiple models and triggering conditions, may operate similarly, as would data aggregation at the end of the process(es) herein disclosed.

As used herein, the term “object detection” is intended to refer generally to computer vision techniques in which objects are detected or identified in a digital image. The term “object detection” as used in the present disclosure includes but is not intended to be limited to the specific computer vision technique of “Object Detection” in which all instances of known object classes are localized and classified in a digital image. For example, the term “object detection” as used herein is intended to include image segmentation techniques in which presence of objects in a digital image are marked using pixel-wise masks for each object in the image. One particular example of image segmentation is instance segmentation in which objects in a digital image are detected and segmented via the localization of specific objects and the association of their belonging pixels. Instance segmentation includes identifying each object instance for every known object within a digital image and includes assigning a label to each pixel of the digital image. Accordingly, reference to “model”, “object detection model”, “neural network”, “object detection neural network”, or the like are intended to include embodiments in which an instance segmentation model or neural network is used and embodiments in which an “Object Detection” model or neural network is used.

As described herein, in an embodiment, the present disclosure provides a multi-model architecture including a plurality of neural networks configured to receive input data and generate at least one output. The neural network may be a feed-forward neural network. The neural network may have a plurality of processing nodes. The processing nodes may include a multi-variable input layer having a plurality of input nodes, at least one hidden layer of nodes, and an output layer having at least one output node. During operation of the neural network, each of the nodes in the hidden layer applies an activation/transfer function and a weight to any input arriving at that node (from the input layer or from another layer of the hidden layer). The node may provide an output to other nodes (of a subsequent hidden layer or to the output layer). The neural network may be configured to perform a regression analysis providing a continuous output, or a classification analysis to classify data. The neural networks may be trained using supervised or unsupervised learning techniques, as described below. According to a supervised learning technique, a training dataset is provided at the input layer in conjunction with a set of known output values at the output layer. During a training stage, the neural network may process the training dataset. It is intended that the neural network learn how to provide an output for new input data by generalizing the information it learns in the training stage from the training data. Training may be effected by back propagating the error to determine weights of the nodes of the hidden layers to minimize the error. Once trained, or optionally during training, test or verification data can be provided to the neural network to provide an output. A neural network may thus cross-correlate inputs provided to the input layer to provide at least one output at the output layer. The output provided by a neural network in each embodiment is preferably close to a desired output for a given input, such that the neural network satisfactorily processes the input data.

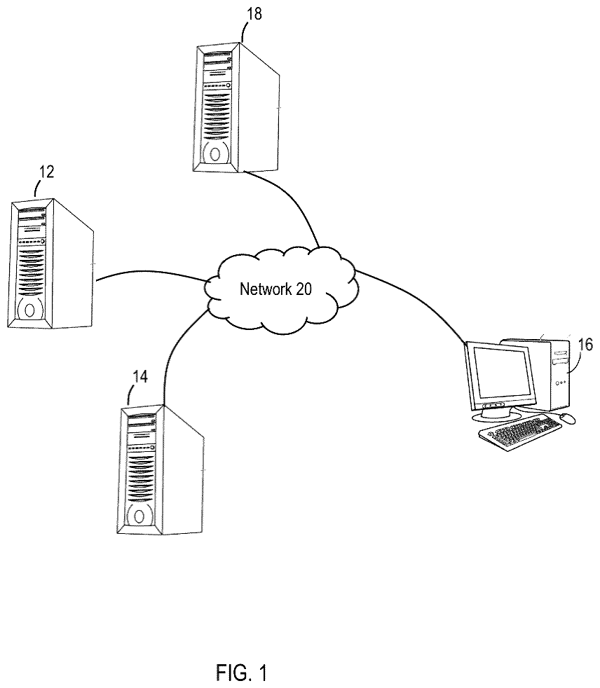

Referring now to FIG. 1, shown therein is an active learning platform system 10, in accordance with an embodiment. The system 10 includes a data storage device 12, an active learning server platform 14, an operator device 16, and an edge cloud mobile device 18 via a network 20.

The devices 12, 14, 16, 18 may be a server computer, node computing device (e.g., JETSON computing device or the like), embedded device, desktop computer, notebook computer, tablet, PDA, smartphone, or another computing device.

The devices 12, 14, 16, 18 may include a connection with the network 20 such as a wired or wireless connection to the Internet. In some cases, the network 20 may include other types of computer or telecommunication networks. The devices 12, 14, 16, 18 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. Processor may execute applications, computer readable instructions or programs. The applications, computer readable instructions or programs may be stored in memory or in secondary storage or may be received from the Internet or other network 20.

Input device may include any device for entering information into device 12, 14, 16, 18. For example, input device may be a keyboard, keypad, cursor-control device, touchscreen, camera, or microphone. Display device may include any type of device for presenting visual information. For example, display device may be a computer monitor, a flat-screen display, a projector, or a display panel. Output device may include any type of device for presenting a hard copy of information, such as a printer for example. Output device may also include other types of output devices such as speakers, for example. In some cases, device 12, 14, 16, 18 may include multiple of any one or more of processors, applications, software modules, second storage devices, network connections, input devices, output devices, and display devices.

Although devices 12, 14, 16, 18 are described with various components, one skilled in the art will appreciate that the devices 12, 14, 16, 18 may in some cases contain fewer, additional or different components. In addition, although aspects of an implementation of the devices 12, 14, 16, 18 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the devices 12, 14, 16, 18 and/or processor to perform a particular method.

Devices 12, 14, 16, 18 can be described performing certain acts. It will be appreciated that any one or more of these devices may perform an act automatically or in response to an interaction by a user of that device. That is, the user of the device may manipulate one or more input devices (e.g., a touchscreen, a mouse, or a button) causing the device to perform the described act. In many cases, this aspect may not be described below, but it will be understood.

As an example, it is described below that the devices 12, 14, 16, 18 may send information to one or more other device 12, 14, 16, 18. For example, a user using the operator device 16 may manipulate one or more inputs (e.g., a mouse and a keyboard) to interact with a user interface displayed on a display of the device 16. Generally, the device may receive a user interface from the network 20 (e.g., in the form of a webpage). Alternatively, or in addition, a user interface may be stored locally at a device (e.g., a cache of a webpage or a mobile application).

The devices 12, 14, 16, 18 may be configured to receive a plurality of information, from one or more of the plurality of devices 12, 14, 16, 18.

In response to receiving information, the respective device 12, 14, 16, 18 may store the information in storage database. The storage may correspond with secondary storage of one or more other devices 12, 14, 16, 18. Generally, the storage database may be any suitable storage device such as a hard disk drive, a solid-state drive, a memory card, or a disk (e.g., CD, DVD, or Blu-ray etc.). Also, the storage database may be locally connected with the device 12, 14, 16, 18. In some cases, storage database may be located remotely from the device 12, 14, 16, 18 and accessible to the device 12, 14, 16, 18 across a network for example. In some cases, storage database may comprise one or more storage devices located at a networked cloud storage provider.

The data storage device 12 may be a cloud accessible data storage device which may store data for retrieval by other components of system 10, through network 20.

The active learning server platform 14 may communicate with data storage device 12 to retrieve training data to train a machine learning model. The platform 14 may communicate with data storage device 12 to retrieve a pretrained machine learning model for further training. Once the active learning platform has trained a machine learning model, the active learning server platform 14 may transmit the model to edge cloud mobile device 18 over network 20 for model deployment.

The operator device 16 comprises a computer terminal that may be used by a human operator to control system 10. The operator device 16 may be coupled to active learning server platform 14 such that operator device 16 may adjust the parameters and control the operation of active learning server platform 14. The operator device 16 includes a user interface component (or module) (e.g., a human-machine interface).

The user interface component of the operator device 16 may also render one or more user interface elements for receiving input from the operator or displaying outputs of the system 10 (e.g. model performance metrics). For example, the user interface component may provide a yes/no or similar binary option for receiving user input data indicating a selection of an option.

The edge cloud mobile device 18 is configured to deploy a trained machine learning module trained by active learning server platform 14. The edge cloud mobile device 18 comprises a general purpose or purpose build computing device which may execute a trained machine learning model. The edge cloud mobile device 18 may communicate with active learning server platform 14 to receive trained machine learning models from active learning server platform 14. The device 18 may send model performance data to the platform 14 indicating performance of the deployed model. In some cases, the received model performance data may be used by the platform 14 in retraining the model using the active learning platform.

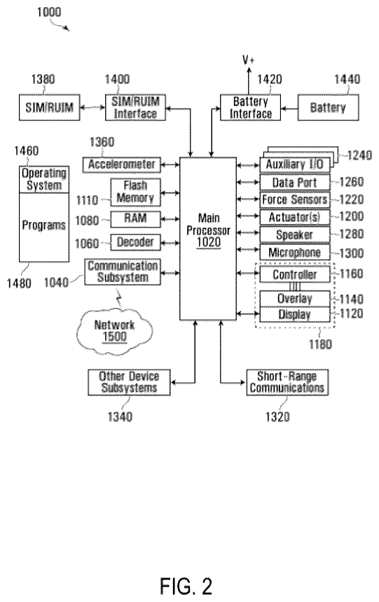

Referring now to FIG. 2, FIG. 2 shows a simplified block diagram of components of a computing device 1000, such as a mobile device or portable electronic device, according to an embodiment. Software modules described in the disclosure herein may be configured to run on a computing device, such as device 1000 of FIG. 2. The device 1000 includes multiple components such as a processor 1020 that controls the operations of the device 1000. Communication functions, including data communications, voice communications, or both may be performed through a communication subsystem 1040. Data received by the device 1000 may be decompressed and decrypted by a decoder 1060. The communication subsystem 1040 may receive messages from and send messages to a wireless network 1500.

The wireless network 1500 may be any type of wireless network, including, but not limited to, data-centric wireless networks, voice-centric wireless networks, and dual-mode networks that support both voice and data communications.

The device 1000 may be a battery-powered device and as shown includes a battery interface 1420 for receiving one or more rechargeable batteries 1440.

The processor 1020 also interacts with additional subsystems such as a Random Access Memory (RAM) 1080, a flash memory 1100, a display 1120 (e.g. with a touch-sensitive overlay 1140 connected to an electronic controller 1160 that together comprise a touch-sensitive display 1180), an actuator assembly 1200, one or more optional force sensors 1220, an auxiliary input/output (I/O) subsystem 1240, a data port 1260, a speaker 1280, a microphone 1300, short-range communications systems 1320 and other device subsystems 1340.

In some embodiments, user-interaction with the graphical user interface may be performed through the touch-sensitive overlay 1140. The processor 1020 may interact with the touch-sensitive overlay 1140 via the electronic controller 1160. Information, such as text, characters, symbols, images, icons, and other items that may be displayed or rendered on a portable electronic device generated by the processor 102 may be displayed on the touch-sensitive display 118.

The processor 1020 may also interact with an accelerometer 1360 as shown in FIG. 2. The accelerometer 1360 may be utilized for detecting direction of gravitational forces or gravity-induced reaction forces.

To identify a subscriber for network access according to the present embodiment, the device 1000 may use a Subscriber Identity Module or a Removable User Identity Module (SIM/RUIM) card 1380 inserted into a SIM/RUIM interface 1400 for communication with a network (such as the wireless network 1500). Alternatively, user identification information may be programmed into the flash memory 1100 or performed using other techniques.

The device 1000 also includes an operating system 1460 and software components 1480 that are executed by the processor 1020 and which may be stored in a persistent data storage device such as the flash memory 1100. Additional applications may be loaded onto the device 1000 through the wireless network 1500, the auxiliary I/O subsystem 1240, the data port 1260, the short-range communications subsystem 1320, or any other suitable device subsystem 1340.

For example, in use, a received signal such as a text message, an e-mail message, web page download, or other data may be processed by the communication subsystem 1040 and input to the processor 1020. The processor 1020 then processes the received signal for output to the display 1120 or alternatively to the auxiliary I/O subsystem 1240. A subscriber may also compose data items, such as e-mail messages, for example, which may be transmitted over the wireless network 1500 through the communication subsystem 1040.

For voice communications, the overall operation of the portable electronic device 1000 may be similar. The speaker 1280 may output audible information converted from electrical signals, and the microphone 1300 may convert audible information into electrical signals for processing.

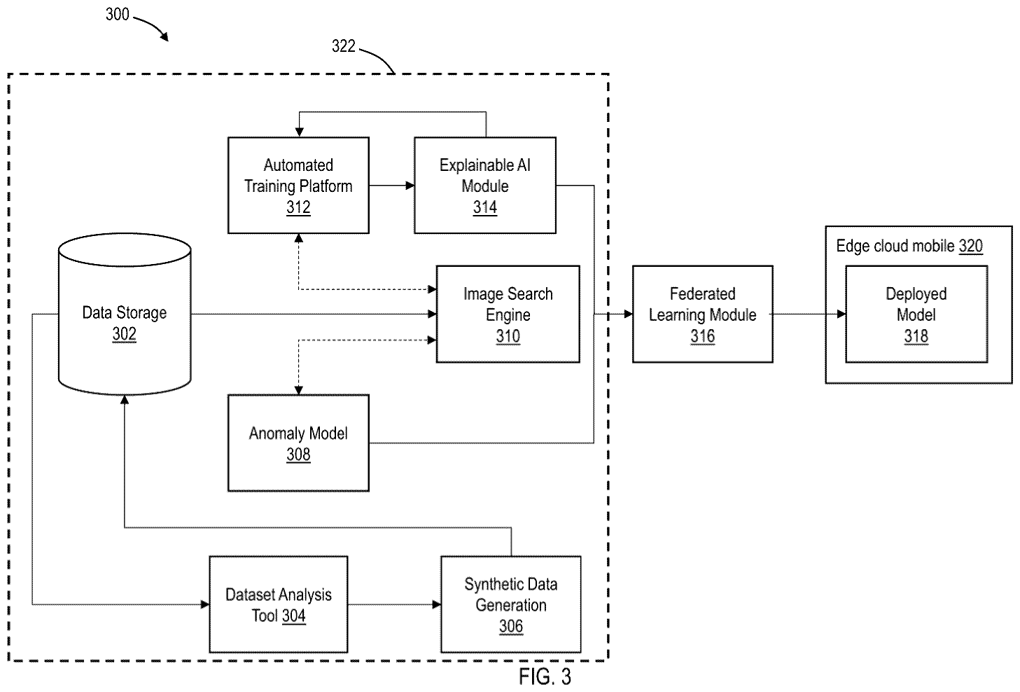

Referring now to FIG. 3, shown therein is a block diagram of a computing system 300 for performing active learning, according to an embodiment. System 300 comprises data storage 302, dataset analysis tool 304, synthetic data generation 306, anomaly model 308, image search engine 310, automated training platform 312, explainable AI module 314, federated learning module 316, deployed model 318, edge cloud mobile 320, and active learning platform 322.

Components 302, 304, 306, 308, 310, 312, 314, and 316 comprise software modules which may be executed on any general-purpose computing device. In some examples, these components may all be collectively executed by a single general-purpose computing device. In other examples, each software module may be executed on a separate general-purpose computing device, wherein each general-purpose computing device is networked such that components may pass data to other components.

Active learning platform 322 comprises modules 302, 304, 306, 308, 310, 312, and 314. Active learning platform 322 may further comprise a management module (not pictured), which may manage the operation and interaction of the modules comprising active learning platform 322. Management module may be coupled to an analyst terminal, such that a human analyst may adjust operational parameters of active learning platform 322 and control the operation of the active learning platform 322. For example, the analyst may specify a subset of data residing on data storage 302 for further processing, start and stop model training, or adjust model hyperparameters. Management module may be implemented at operator device 16 of system 10.

Data storage 302 may comprise cloud hosted, network accessible non-transient computer-readable memory.

Data storage 302 may comprise a hard drive, NAND flash, or other non-transient computer-readable memory.

Data storage 302 may store any form of data, including without limitation, source code, image data, text data, and video data.

In some examples, data storage 302 may be hosted privately. For example, an entity may privately own server equipment, which may be connect to a network, such as the Internet, such that the data storage 302 may be accessible to any authorized individual or entity with access to the network.

In other examples, data storage 302 may comprise a cloud storage instance provided by a commercial cloud services provider, such as Microsoft Azure, Amazon Web Services or Google Cloud.

Stored on data storage 302 may be a dataset, wherein the dataset comprises a plurality of data samples. Data samples may comprise images, video, text, or other formats of data. Data samples may comprise training data samples, validation data samples, and input data samples. Data samples may comprise a plurality of data classes, wherein class may be defined, for example in an image classification use case, as an image type, image subject or specific feature within an image. Each data sample may be further associated with metadata, such as a class label, or other metadata.

Dataset analysis tool 304 comprises a software module configured to analyze a dataset of images.

The tool 304 may cluster provided image data samples into broad or narrow categories, calculate statistics on the generated data clusters, and direct further action on the provided image data depending on the calculated statistics.

The statistics calculated by tool 304 may be used to indicate whether the data set is a sufficient data set for training a machine learning model (e.g. the platform can sufficiently learn from the dataset) or an insufficient or inappropriate dataset. Sufficiency may be measured, for example, by sectioning and/or sparsity. If the dataset is not sufficient, then there is a need to augment/improve the data set such that the model learned through the training process on the dataset provides for acceptable model performance. For example, if the model is an image classification model, the model may be deemed to provide acceptable performance when the accuracy of image classification surpasses a predetermined accuracy threshold.

Tool 304 may be configured to, after clustering, determine if any classes of the dataset lack sparsity, or if any data classes lack data samples.

Tool 304 may identify one or more classes of concern based on the output of the analysis. In such examples, tool 304 may output data describing one or more classes of data needed. Such an output may comprise a class label or description (e.g. a text or metadata format description of the class), or an image (or plurality of images) from the class.

Dataset analysis tool 304 is coupled to data storage 302, such that dataset analysis tool 304 may access and process data stored on data storage 302.

Dataset analysis tool 304 may receive a plurality of images from data storage 302.

Dataset analysis tool 304 may perform an analysis operation to place images into clusters, wherein images within each cluster include similarities.

Dataset analysis tool 304 may employ various methods to cluster images, for example, without limitation, k-means, SVMs, random forest clustering and UMAP architectures.

Once dataset analysis tool 304 clusters images into categories, dataset analysis tool 304 may then proceed to calculate statistics on each cluster.

For example, dataset analysis tool 304 may make determinations as to if each cluster includes a sufficient number of images such that a machine learning-based inspection tool trained using each cluster may accurately identify images of each cluster. In addition to number of images in each cluster, dataset analysis tool 304 may quantify variation of the images within the cluster. For example, a cluster may include 5 images which are all nearly identical (e.g. 5 distinct car images of the same make, model and color of car). Such a cluster may be deemed to have relatively low variation within the cluster.

In another example, a cluster may include 5 images, each very different (e.g. 5 car images, each with a distinct make, model and color of car). Such a cluster may be deemed to have a relatively high variation.

Various image analysis tools and algorithms may be applied to quantify image variation.

While description above in reference to dataset analysis tool 304 is focused on image data, in other embodiments, dataset analysis tool 304 may be configured to process other forms of data, for example, video data.

Synthetic data generation module 306 comprises a software module configured to generate synthetic data.

In some examples, the synthetic data generated may comprise image data. In such examples, the synthetic data generation module may be provided with a training image dataset, wherein the synthetic data generation module 306 may generate image data that is similar to the training image dataset. For example, if the training image dataset comprises images of a certain image class, synthetic data generation module 306 may generate and output images of the same image class.

Synthetic data generation module 306 may include a trained machine learning model. The machine learning model may be a neural network.

In some examples, synthetic data generation module 306 may comprise at least one generative adversarial network (GAN). The GAN may be trainable using a provided image data set.

Synthetic data generation module 306 is coupled to data storage 302, such that synthetic data generation module 306 may access and process data stored on data storage 302.

A plurality of data, such as a plurality of image files, may be provided to synthetic data generation module 306, to train synthetic data generation module 306.

Synthetic data generation module 306, once trained, may be directed to output a plurality of synthetic images similar to the provided input training images.

Synthetic data generation module 306 may be configured to output synthetic images to data storage 302 for data storage of these synthetic images.

Anomaly model 308 comprises a software module configured to receive a plurality of training set images as a training input. Training set images may preferably comprise images of image subjects in a manually verified acceptable condition.

Once anomaly model 308 has been trained, anomaly model 308 is configured to receive an input image and perform an analysis on the input image to determine whether the input image comprises image anomalies. In some examples, anomalies may comprise features generally not present in the training set images.

Anomaly model 308 may employ any data anomaly model or data anomaly detection algorithm known in the art to detect anomalies within input images.

If the anomaly model 308 detects an anomaly in an image, anomaly model 308 may subsequently identify a general area within the image wherein the anomaly lies. The anomaly model 308 may subsequently crop this area, generating a cropped anomaly image for further processing or use, or draw a bounding box around the area wherein the anomaly lies, and record the position information of the bounding box for further processing or use.

In some examples, anomaly model 308 may be further configured to classify objects (e.g. defects) located within the image.

In some examples, anomaly model 308 may include a generative model subcomponent, a comparison module subcomponent, and an anomaly classifier module subcomponent.

In some examples, the generative model subcomponent may include a neural network. In some examples, the neural network may be a generative adversarial network (GAN).

The generative model may be trained using training sample data deemed to comprise “good” samples. For example, if system 300 is configured to process image data, the sample data may comprise “good” images, wherein the images comprise only desirable features or a high proportion of desirable features. Once trained, the generative model may be provided with an image of the same class as the training sample images as an input and may output an image comprising a “good” variation of the input image.

In such an example, once the anomaly model 308 has been trained with such an image dataset, the anomaly model 308 is ready to receive an input. An input image is provided to anomaly model 308. The input image may be provided to the generative model of the anomaly model 308. The generative model of anomaly model may generate a golden image output corresponding to the input image, wherein the golden image output is a “good” or “clean” variation of the input image.

The input image and golden image output may then be provided to the comparison module as an input. In turn, the comparison module may output image comparison data descriptive of the differences between the input image and golden image output. For example, if the input image includes a defect that is not present in the golden image output, the image comparison data may indicate the presence of this defect. It should be noted that a general purpose of the golden image is to provide a “good” or “clean” version of the input image such that any defects or anomalies (or other visual artifacts) present in the input image are not present (i.e. removed) from the golden image and can be identified through the comparison of the input image to the golden image.

In an embodiment, a direct image comparison is performed by the comparison module using matrix subtraction or pixel to pixel greyscale subtraction. The input and output are the same dimensions (same as actual input image (e.g. 512*512 from autoencoder scaled back to 300*1000)) and only one value per pixel is subtracted.

The image comparison output data includes differences that have been identified by the image comparison process. In an embodiment, the image comparison output data is a greyscale image (e.g. 300*1000) containing differences between the inspection image and the generative golden image. As previously described, the differences generally correspond to differences present in the inspection image and not present in the golden image.

The input image, golden image, and image comparison data may be provided to anomaly classifier module, which may then output anomaly classification data, which may then be outputted from anomaly model 308.

Anomaly classification data may include a class label for each located anomaly. The anomaly classification data may also include location data specifying the location of each anomaly. Location data may include pixel coordinates of a bounding box for each anomaly.

The anomaly classifier module may comprise a machine learning model, such as a neural network (e.g. CNN). In an embodiment the classifier module is a hybrid CNN binary classifier. In another embodiment, the classifier module may be a fine-tuned CNN.

In some examples, the classifier module may include a hybrid CNN binary classifier. A hybrid CNN binary classifier may be a combination of convolution layers (from a pre-trained CNN) and a support vector machine (“SVM”) classifier. The SVM classifier may be trained on a small set of project specific images. With sufficient training samples, the hybrid CNN may be swapped with a fine-tuned CNN.

In a specific example, anomaly model 308 may be applied to an optical object inspection system. A training set of object images of objects known to comprise no defects may be provided to the anomaly model 308 for training.

Once trained, an inspection image of an object of unknown defect condition may be provided to anomaly model 308 as an input. The inspection image may then be passed to the trained generative model as an input, which may then output a golden variation of the inspection image, wherein the golden variation of the inspection image includes no defects. The golden variation of the inspection image and the inspection image may be passed to the comparison module as an input. In turn, the comparison module may output image comparison data, detecting differences between the golden variation of the inspection image and the inspection image. The comparison module may provide image comparison data to anomaly classifier module, which may subsequently classify the detected differences between the golden variation of the inspection image and the inspection image. For examples, differences may be classified as certain known types of object defects. Anomaly classifier module may then output anomaly classification data from anomaly model 308.

Image search engine 310 comprises a software module configured to receive an image as an input, and search through a plurality of accessible images for images similar to the input image.

For example, image search engine 310 may be coupled to data storage 302 and may access a plurality of indexed images stored on data storage 302. Indexed images may be stored in a database.

Image search engine 310 may analyze the provided input image, and indexed images, and return references to images which are deemed similar to the input image.

In an embodiment, image search engine 310 may generate a feature embedded vector corresponding to the provided image and may use the feature embedded vector to locate similar images in the database.

Image search engine 310 may employ any image search algorithm known in the art to conduct image searching.

Automated training platform 312 comprises a software module configured to receive training set image data and train a machine learning model for deployment. The machine learning model trained by automated training platform 312 may comprise an image segmentation model. The image segmentation model may be an instance segmentation model. The machine learning model trained by automated training platform may be an object detection model. The machine learning model trained by automated training platform may be a machine learning model configured to perform at least one computer vision task. The at least one computer vision task may include, for example, any one or more of object detection, object tracking, image classification, semantic segmentation, and instance segmentation.

Explainable AI module 314 comprises a software module configured to communicate with automated training platform 312.

For each image inputted into the model trained by automated training platform, explainable AI module 314 may generate an output comprising data providing insight into the interaction between each input image and the output of the model trained by automated training platform.

In some examples, this output may comprise a class activation map corresponding to each input image provided to the trained machine learning model.

Explainable AI module 314 may be configured to provide an output to another software module for further processing.

The output of the explainable AI module 314 may include any one or more of predictions, confidence levels, heat maps, and other information that describes how inputs affect the internal layers and activation information of model 308 layers. This output data enables the optimization of selected input data and may guide hyperparameter tuning to further optimize model 308 performance.

Federated learning module 316 comprises a software module configured to receive data from active learning platform 322.

Federated learning module 316 may receive at least one partially trained machine learning model from active learning platform 322.

Federated learning module 316 may provide additional training data to the partially trained model to further train the partially trained model, generating a federated-trained machine learning model.

In some examples, the partially trained model received by federated learning module 316 may comprise trained anomaly model 308, configured for image anomaly detection, and or a model trained by automated training platform 312, configured for image segmentation.

In some examples, the federated-trained machine learning model may be transmitted back to active learning platform 322 for incorporation of the federated-trained machine learning model into the active learning platform 322.

In some examples, system 300 may comprise a plurality of federated learning modules 316, which may be distributed across a plurality of physical sites.

Deployed model 318 comprises a trained machine learning model, which may be executed on a general purpose-or purpose-built electronic computer.

Deployed model 318 may receive an image as an input, and output data relating to the input image, such as objects located within the image (e.g. defects, anomalies, other artifacts), classification of objects located within the image, locations of objects within the image and other related metadata, for example date and time of analysis, or hardware identifiers of the hardware on which deployed model 318 is deployed.

Deployed model 318 may be trained and or generated by federated learning module or active learning platform 322.

In some examples, deployed model 318 may comprise trained anomaly model 308, configured for image anomaly detection, and or a model trained by automated training platform 312, configured for image segmentation or image anomaly detection.

Edge cloud mobile device 320 comprises a computing device or service upon which the deployed model 318 is executed.

The edge cloud mobile device 320 may comprise an edge computing device.

In other examples, edge cloud mobile device 320 may comprise a cloud computing device. Cloud computing device may comprise a cloud computing instance on a commercial cloud computing service, such as Amazon Web Services, Microsoft Azure, Google Cloud or other commercial cloud computing services.

In other examples, cloud computing device may comprise a private cloud computing device, owned and operated by the same entity that is deploying the deployed model 318.

In other examples, the edge cloud mobile device 320 may comprise a mobile device, such as a smartphone, tablet, laptop computer or other relatively portable computing device.

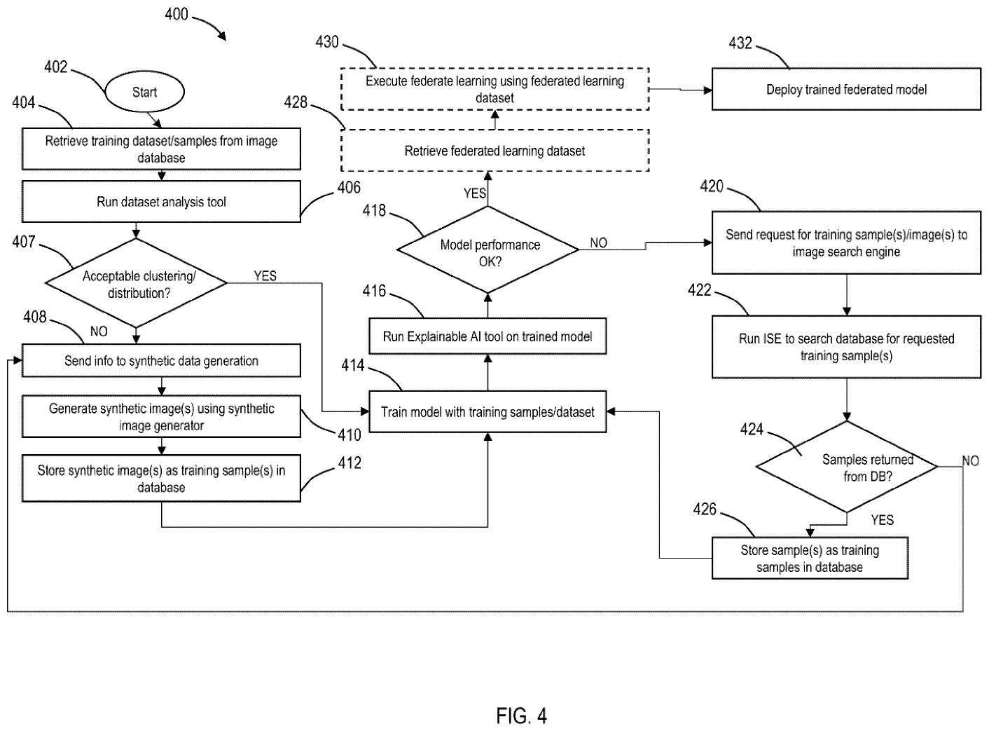

Referring now to FIG. 4, shown therein is a flow chart describing a method 400 of operation of a computing system, such as system 300 of FIG. 3, according to an embodiment. Method 400 describes the operation of an active learning platform system configured to process image datasets, however, in other examples, the method may be modified to process other forms of data, such as video data, audio data or text data.

Method 400 may begin at 402, wherein the method is started. In an example, system 300 may begin operation when an operator transfers a set of images to data storage 302, triggering 402, which may initiate method 400.

At 404, training datasets/samples are retrieved from an image database, such as data storage 302.

Once datasets/samples are retrieved from the image database, the method may proceed to 406, wherein the dataset analysis tool is run.

Dataset analysis tool may be dataset analysis tool 304 of system 300. Dataset analysis tool may calculate sample size and sparsity of datapoints within the datasets/samples.

Based these sample size and sparsity calculations, at query 407, it may be decided whether the dataset/samples comprise acceptable clustering or distribution for further use within the active learning system for training a machine learning model. Such a decision may be based on application requirements and depend on the ability of the methods and systems described herein to generalize over all unique samples provided to the methods and systems described herein across a diverse dataset. The diversity of the dataset may be calculated based on a combination of application requirements, the nature of how certain objects may change, and data clustering diversity.

In examples of method 400 wherein it is determined that the dataset/samples do not provide acceptable clustering or distribution, the data within the dataset/samples that are deemed to be insufficient may be provided to a synthetic data generation component, such as synthetic data generation module 306 of system 300.

As described above in reference to system 300, synthetic data generation module 306 may receive sample data, wherein the sample data may comprise a subset of the dataset retrieved at 404. This sample data may be used to train the synthetic data generation component.

At 410, after the synthetic data generation component has been trained, the synthetic data generation component may output synthetic data that is similar in character to the sample data provided to the synthetic generation component for training.

At 412, the synthetic data generated by the synthetic generation component at 410 may be stored as training dataset/samples, for example, in data storage 302. The synthetic data may be integrated into the dataset first retrieved at 404, such that the dataset now comprises a combination of the original dataset (or some portion thereof) and the synthetic data generated at 410.

Method 400 may now proceed to 414. In examples wherein at 407 it was determined that the dataset was appropriately distributed and clustered, method 400 may proceed directly from 407 to 414.

At 414, a machine learning model is trained with the current dataset.

In the example of method 400, the machine learning model may comprise a model of automated training platform 312 of system 300. In other examples, the machine learning model may comprise another model.

After the completion of 414, the model is trained. The model may now be assessed for performance.

At 416, an explainable AI tool may be executed to assess the performance of the model trained at 414. For example, the explainable AI tool may comprise explainable AI module 314 of system 300. At 416, the explainable AI may generate an output characterizing the performance of the model trained at 414. The explainable AI may further provide information as to how the model is failing to perform its design objective.

At 418, the performance of the model trained at 418 may be assessed according to the output characterizing the performance of the model generated at 416. Based on this output, it may be determined that the model comprises acceptable performance, or performance that is unacceptable.

In some examples, model performance may be assessed by measuring model output accuracy versus a known sample set. This assessment may be performed by measuring model performance versus known samples and comparing performance to pre-determined thresholds for certain attributes, such as, without limitation, precision, recall, and/or intersection over union.

For example, the model trained at 414 may comprise an image classifier. A verification dataset may exist. The verification dataset may comprise a set of images of known classes. These images may be provided to the model trained at 414 for classification of the images. If a proportion of images above a preset threshold have been incorrectly classified, it may be deemed at 418 that the trained model is providing for insufficient performance. In such an example, method 400 may proceed to 420.

In some examples, human factors may be additionally considered when assessing model performance. Human factors may be used to provide understanding as to how the model evolves when new information or data is added to the model, enabling an operator to ensure that the model retains the highest possible generalization capacity across all provided samples.

At 420, images which have been classified incorrectly, or images which have been otherwise deemed to cause poor model performance, may be passed to explainable AI tool. The explainable AI tool may in some examples detect a region or regions of the input image wherein the model trained at 414 provided for poor performance with the input image. These regions may be cropped or otherwise indicated for provision to an image search engine tool (for example, image search engine 320) at 420. Alternatively, the uncropped image may be passed to an image search engine tool. This operation may be conducted on all improperly classified images, or otherwise difficult to process images.

At 422, the image search engine tool may search the image database queried at 404 (e.g. data storage 302) for images similar to the image regions or crops provided to the image search engine tool as an input.

At 424, it is determined whether such images may be located by the image search engine tool. If such images are located, the method may proceed to 426. If such images are not located, the method may proceed back to 408.

At 426, the images located by image search engine at 422 may be stored as training samples in the database. After storing these images, the method may return to 414, wherein the model may be retrained, such that the training dataset now includes the newly located images. After training at 414, the method may proceed again to 416 and then 418 as described above.

If no samples are returned by image search engine at 424, the method may proceed back to 408, and the samples of interest (e.g. incorrectly classified images) may be provided to synthetic image generator module as an input, and the method may proceed to 410 once again to generate synthetic image data characteristic of the problematic images or image portions provided as an input.

Once such images are generated, they may be stored in the training dataset at 412, and the method 400 may proceed to 414 to retrain the model with the updated dataset and continue to 416 as described above.

Once at 418 it is determined that model performance is sufficient, the model may be deployed for federated training at 428 and 430.

At 428, a federated learning dataset is retrieved. For example, the model may be deployed to a remote site as trained after 414. At the remote site, the model may be further trained with an offsite dataset, such that the model is refined with this additional offsite input. Once trained, a federated training dataset may be outputted by this further trained model and transmitted back to the automated training platform system.

The federated training dataset comprises data including the effect of the additional training of the model with the offsite dataset, without including the additional dataset itself.

At 430, the model is trained further using the federated learning dataset retrieved at 428. The changes to the model stemming from the further training with the offsite dataset may be incorporated into the model, for further deployment.

In some examples of method 400, multiple iterations of federated learning may be applied to the model.

The federated training architecture applied at 428 and 430 allows the model to be trained with two separate datasets, provided by two different parties, without sacrificing the training data security of each party. For example, the operator of method 400 may access the original dataset retrieved at 404 but may not access the contents of the offsite dataset. Similarly, the provider of the offsite dataset may access the contents of the offsite dataset but may not access the contents of the dataset retrieved at 404. The model in question may be collaboratively trained by two (or more) separate parties without requiring any parties to share training datasets with any other party. This may be advantageous as training datasets may comprise commercially valuable data.

At 432, the trained federated model is deployed. The trained federated model may be deployed for execution on a cloud, mobile, edge computing or other computing device. Once deployed, the model may receive an input, and produce outputs according to the model's structure and provided training datasets. Deployed model may correspond to deployed model 318 of system 300.

Advantageously, the method 400 may execute without manual human intervention. In some examples, a skilled human operator may intervene if the method 400 does not meet preset performance metrics and explainable artificial intelligence output differs from what is expected from a well performing model. In some examples, a skilled human operator may inspect encrypted data from components (e.g. federated learning module 316) to analyze failures.

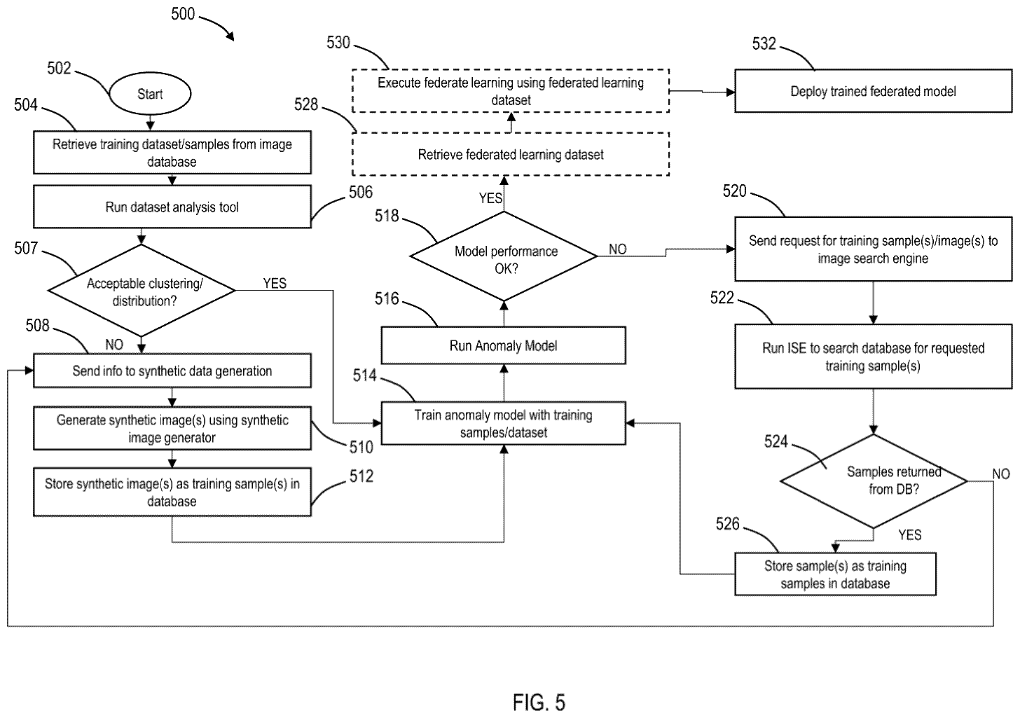

Referring now to FIG. 5, shown therein is method 500, a variant of method 400. Description above in reference to method 400 may apply to method 500. Steps of method 500 may be analogous to method 400, wherein each step number is incremented by 100.

Method 500 differs from method 400 in that method 500 includes the training, execution and assessment of an anomaly model at 514, 516, 518 respectively. The anomaly model may be an anomaly model 308 as described above in reference to system 300.

At 516, instead of running an explainable AI tool on the trained model, the model trained at 514 may be provided with a verification dataset, and the performance of the model may be assessed at 518. Datapoints wherein the model provides for poor performance may be identified and provided to image search engine at 520 for retrieval 522 of similar images from the dataset. If such similar images are located, they may be incorporated into the training dataset and the model may be retrained at 514. If such similar images are not located, the method 500 may call a synthetic image generation component at 510 and provide the synthetic image generation component with an input descriptive of missing image datapoints, such as example images. The synthetic image generation component may in turn output synthetic image data for storage in an image database and incorporated into the training dataset. The model may then be retrained at 514 and the method 500 may proceed as described above in reference to method 400.

In some examples of method 500, the anomaly model of method 500 may be further analyzed using explainable artificial intelligence techniques. Such methods may be analogous to those as described in reference to, at least, step 416 of method 400 described above. Additionally, the anomaly model of method 500 may be further assessed for performance by testing the anomaly versus a validation training set, with known parameters.

While the above description provides examples of one or more apparatus, methods, or systems, it will be appreciated that other apparatus, methods, or systems may be within the scope of the claims as interpreted by one of skill in the art.

1. A computer-implemented method of performing active learning for training and deploying a machine learning model, comprising:
storing, in a data storage device, an image database comprising a first training dataset of training samples;
determining, using a dataset analysis tool executed by at least one processor in communication with the data storage device, a clustering or distribution of the first training dataset;
in response to the clustering or distribution determination, generating by a synthetic image generation module executed by the at least one processor a first set of one or more synthetic images using a subset of the training samples from the first training dataset as input and generating a second training dataset including the first set of one or more synthetic images;
training the machine learning model with the second training dataset to obtain the trained machine learning model;
assessing, using a model performance assessment tool executed by the at least one processor, a performance of the trained machine learning model, the assessing including identifying one or more images in the second training dataset negatively affecting model performance;
sending a request for one or more training samples to an image search engine executed by the at least one processor, wherein the requested training samples are defined using image data from the identified one or more images negatively affecting model performance;
running the image search engine to search the image database for the requested one or more training samples;
where the image search engine returns the requested one or more training samples:
generating a third training dataset including the requested one or more training samples;
training the machine learning model with the third training dataset to obtain the trained machine learning model;
where the image search engine does not return the requested one or more training samples:
generating, by the synthetic image generation module, a second set of one or more synthetic images using image data from the one or more images in the first training dataset that have contributed to unacceptable model performance as input and generating a fourth training dataset including the second set of one or more synthetic images; and
training the machine learning model with the fourth training dataset to obtain the trained machine learning model.

2. The method of claim 1, wherein determining the clustering or distribution of the first training dataset includes calculating sample size and sparsity of datapoints within the first training dataset.

3. The method of claim 1, wherein determining the clustering or distribution of the first training dataset includes performing an analysis operation to place the training samples into clusters, wherein the training samples within each cluster include similarities, and quantifying variation of the training samples within each cluster.

4. The method of claim 1, wherein determining the clustering or distribution of the first training dataset includes the dataset analysis tool determining an ability to generalize over the training samples is insufficient.

5. The method of claim 1, wherein the synthetic image generation module comprises a neural network and is configured to receive one or more training samples of a certain image class and generate and output one or more synthetic images of the same image class.

6. The method of claim 1, wherein assessing the performance of the trained machine learning model includes determining that an accuracy of classification of the trained machine learning model does not meet a predetermined accuracy threshold.

7. The method of claim 1, wherein the image database comprises a plurality of indexed images and the image search engine is configured to analyze an input image and the plurality of indexed images and return references to images in the plurality of indexed images which are similar to the input image.

8. The method of claim 7, wherein the image search engine is configured to generate a feature embedded vector corresponding to the input image and search the plurality of indexed images using the feature embedded vector.

9. The method of claim 7, wherein the model performance assessment tool is configured to detect a region or regions in the one or more images in the second training dataset negatively affecting model performance, and wherein the input image to the image search engine is a cropped image containing the detected region or regions.

10. The method of claim 1, wherein the machine learning model is configured to perform at least one computer vision task including any one or more of object detection, object tracking, image classification, semantic segmentation, and instance segmentation.

11. The method of claim 1, wherein assessing the performance of the trained machine learning model includes generating, by the model performance assessment tool, an output including any one or more of predictions, confidence levels, heat maps, and other information that describes how inputs affect internal layers and activation information of layers of the trained machine learning model.

12. The method of claim 1, wherein assessing the performance of the trained machine learning model includes measuring, by the model performance assessment tool, model output accuracy of the trained machine learning model versus a known sample set, the measuring including measuring performance of the trained machine learning model versus known samples and comparing performance to a predetermined threshold of any one or more of precision, recall, and intersection over union.

13. The method of claim 1, further comprising performing, using at least one federated learning module executed by the at least one processor, a federated learning process using the trained model and additional training data to further train the trained machine learning model to obtain a federated-trained machine learning model, and wherein the method further comprises assessing performance of the federated-trained machine learning model using the model performance assessment tool.

14. The method of claim 13, wherein the additional training data is from at least two physical sites implementing computer vision-based visual inspection.

15. A computer system for performing active learning for training and deploying a machine learning model, comprising:
a data storage device for storing an image database comprising a first training dataset of training samples;
at least one processor in communication with the data storage device, the at least one processor configured to:
determine, using a dataset analysis tool, a clustering or distribution of the first training dataset;
in response to the clustering or distribution determination, generate by a synthetic image generation module a first set of one or more synthetic images using a subset of the training samples from the first training dataset as input and generate a second training dataset including the first set of one or more synthetic images;
train, using an automated training module, the machine learning model with the second training dataset to obtain the trained machine learning model;
assess, using a model performance assessment tool, a performance of the trained machine learning model, the assessing including identifying one or more images in the second training dataset negatively affecting model performance;
send a request for one or more training samples to an image search engine, wherein the requested training samples are defined using image data from the identified one or more images negatively affecting model performance;
run the image search engine to search the image database for the requested one or more training samples;
where the image search engine returns the requested one or more training samples:
generate a third training dataset including the requested one or more training samples;
train the machine learning model with the third training dataset to obtain the trained machine learning model;
where the image search engine does not return the requested one or more training samples:
generate, by the synthetic image generation module, a second set of one or more synthetic images using image data from the one or more images in the first training dataset that have contributed to unacceptable model performance as input and generate a fourth training dataset including the second set of one or more synthetic images; and
train the machine learning model with the fourth training dataset to obtain the trained machine learning model.

16. The system of claim 15, wherein determining the clustering or distribution of the first training dataset includes performing an analysis operation to place the training samples into clusters, wherein the training samples within each cluster include similarities, and quantifying variation of the training samples within each cluster.

17. The system of claim 15, wherein the synthetic image generation module comprises a neural network and is configured to receive one or more training samples of a certain image class and generate and output one or more synthetic images of the same image class.

18. The system of claim 15, wherein assessing the performance of the trained machine learning model includes determining that an accuracy of classification of the trained machine learning model does not meet a predetermined accuracy threshold.

19. The system of claim 15, wherein the image database comprises a plurality of indexed images and the image search engine is configured to analyze an input image and the plurality of indexed images and return references to images in the plurality of indexed images which are similar to the input image.

20. A non-transitory computer-readable medium storing computer-executable instructions which, when executed by at least one processor, cause the at least one processor to execute a method comprising:
storing, in a data storage device, an image database comprising a first training dataset of training samples;
determining, using a dataset analysis tool executed by at least one processor in communication with the data storage device, a clustering or distribution of the first training dataset;
in response to the clustering or distribution determination, generating by a synthetic image generation module executed by the at least one processor, a first set of one or more synthetic images using a subset of the training samples from the first training dataset as input and generating a second training dataset including the first set of one or more synthetic images;
training the machine learning model with the second training dataset to obtain the trained machine learning model;
assessing, using a model performance assessment tool executed by the at least one processor, a performance of the trained machine learning model, the assessing including identifying one or more images in the second training dataset negatively affecting model performance;
sending a request for one or more training samples to an image search engine executed by the at least one processor, wherein the requested training samples are defined using image data from the identified one or more images negatively affecting model performance;
running the image search engine to search the image database for the requested one or more training samples;
where the image search engine returns the requested one or more training samples:
generating a third training dataset including the requested one or more training samples;
training the machine learning model with the third training dataset to obtain the trained machine learning model;
where the image search engine does not return the requested one or more training samples:
generating, by the synthetic image generation module, a second set of one or more synthetic images using image data from the one or more images in the first training dataset that have contributed to unacceptable model performance as input and generating a fourth training dataset including the second set of one or more synthetic images; and
training the machine learning model with the fourth training dataset to obtain the trained machine learning model.
